(19) United States
(12) Patent Application Publication
(10) Pub. No.: US 2017/0345077 A1
(43) Pub. Date: Nov. 30, 2017

(54) System and method for providing a promotional shopping data platform AWS™ for consumers

(71) Applicant: Ahmed Sultan, Grovetown, GA (US)

(72) Inventor: Ahmed Sultan, Grovetown, GA (US)

(21) Appl. No.: 15/678,399

(22) Filed: Aug. 16, 2017

(51) Int. Cl. G06Q 30/06; G06F 17/30; G06Q 30/02

(52) U.S. Cl. CPC G06Q 30/0625; G06Q 30/0277; G06F 17/30241; G06Q 30/0239

(57) ABSTRACT

System and method for providing a promotional shopping data platform AWS™ for consumers is disclosed. The method includes America's Weekly Sales™ or AWS™ Site searched by consumers. Consumers select their location producing content data. This content data is based on categories selected by relevancy of the consumer's choice. The content data will be of promotional discounts and savings for the consumer to shop at a local store in their city. The promotional discounts are posted by vendors that have small businesses in a local city.

### BACKGROUND OF THE INVENTION

Prior art promotional sites have not addressed the need to focus on local small businesses to help build their brand as described in the present invention. Prior promotional advertising sites are basically used to help promote large corporations. Many big businesses such as large corporations use advertising and marketing by print, online, radio, TV, etc. but this can be a very expensive process. Small businesses are most of the time locked out of traditional advertising because of costs. Using the present invention makes advertising affordable for small business owners. There is currently no system and methods to provide the consumer promotions in their city that is updated frequently by a local small business owner. Promotional discounts are an integral part of vendors tactics to increase sales for many goods and services. Promotional discounts promote new and existing goods and services and also helps consumers pay less to save money as many households are on budgets. More than 45 million Americans lived below the poverty line in 2013 reported by the Census Bureau, so using promotional discounts will be beneficial to many people.

### Field of Invention

The embodiments herein generally relate to the offer of promotions for goods and services by vendors, and more specifically to a system and method for offering goods and services of vendors that are at a discount on AWS's™ website, wherein the goods or services are offered by local small businesses with accounts with AWS's™ website.

### SUMMARY OF THE INVENTION

For the present invention small business vendors pay a fee to post promotions on AWS™'s Site. This system helps to build the businesses brand through exposure and giving traction in an web-based environment by AWS™ r America's Weekly Sales™ Website or Site by advertising to consumers. More specifically, the system creates and administers a system that displays advertisements that are correlated to a given user with content data based on relevance by the user/consumer. The correlation between advertisement and user in one embodiment of the invention is based on a user's zip code. Further, this system is fast, simple and easy for a user that wants to quickly view ads in their areas or for businesses that wants to post in an effective way. AWS™ is a mobile application and/or website platform in which consumers or users can use the platform to search for promotional discounts in their city and vendors post their promotions to gain business.

In a preferred embodiment the present invention will include the steps of enabling a website-Internet advertising services account. In order to post on the Site, a business owner must pay a fee and agree to the terms of service. First a business owner will visit the Site and click on post a promo, then select a category, add details of the advertisement and location, agree to the Terms of Use and Privacy Policy and then make a payment.

Each business service or product promotion to display by implementation from stored information on the Site's server that displays content data associated with a local area for the consumer. The present invention works in an affordable and rapid manner, and helps local businesses build their brand locally.

In response to a category selection, options are displayed and provided to the index for retrieving local content relevant to the category selected.

It is therefore an object of the present invention to provide a system for promotional advertising online on any computer device that is free for consumers. Revenue is achieved from fees for the businesses at an affordable rate for a 7 day duration.

Merchants can update or renew their promotional offers at any time.

The vendor can post a number of promotions they want to offer. The local small businesses transact sales through a physical store. AWS™ does not handle any web transactions for its vendors.

### BRIEF DESCRIPTION OF THE DRAWINGS

FIG. 1 is a schematic diagram (201) illustrating a system used to carry out the invention.

### DETAILED DESCRIPTION OF THE DRAWINGS

The present invention can be understood in the connection of the accompanying figure. It is noted that the invention is not limited to the precise embodiments shown in which:

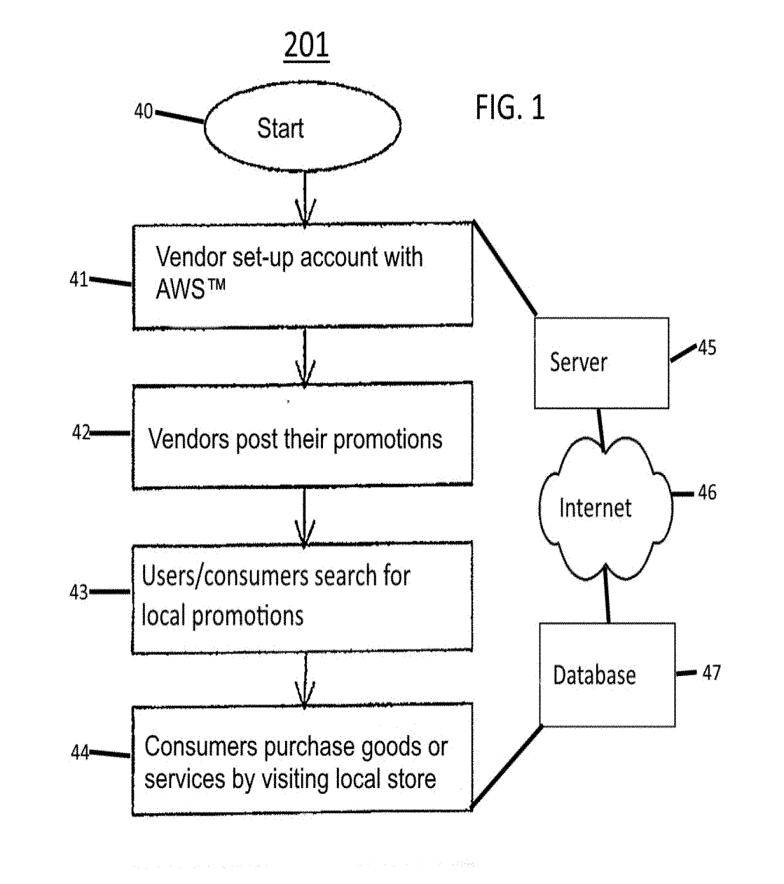

FIG. 1 is a schematic diagram (201) illustrating a system used to carry out the invention. (40) is displaying the start of using the system by a small business vendor. The small business vendor gets an account (41) with AWS™. Small business vendors (42) can post their promotions on the Site. Consumers can search the Site for local promotions (43). The users/consumers (44) can view the promotions posted and visit a local store in there area to purchase goods or services. AWS™ has a server (45) that will store, process and deliver the data for the Site. The internet (46) is how the Site is accessed online. The database (47) will serve tasks such as retrieval of data, analysis, storage and archiving.

1. System and method for providing a promotional shopping data platform AWS™ online for vendors and consumers, comprising:
a business working with AWS™ by setting-up their accounts and posting their promotions.

2. A user or consumer can search AWS™'s Site by generating a selectable category selection of their choice and receive a search result responsive to the search request, the search result comprising store location and product or service promotions.

3. The method of claim 2 further including receiving user location information and generating search results that accounts for a store's location relative to the user's location information.

4. The method of claim 1 further including a system for facilitating a sales transaction by the vendor's creation of sales promotions in the forms of discounts.
